(19) United States
(12) Patent Application Publication
(10) Pub. No.: US 2002/0124097 A1
(43) Pub. Date: Sep. 5, 2002

(54) Methods, systems and computer program products for zone based distribution of audio signals

(76) Inventors: Larson J. Isely, Durham, NC (US); Gary D. Deen, Durham, NC (US); Gregory T. Knowles, Raleigh, NC (US); Brian T. Webb, Raleigh, NC (US)

Correspondence Address: MYERS BIGEL SIBLEY & SAJOVEC, PO BOX 37428, RALEIGH, NC, 27627, US

(21) Appl. No.: 09/751,098

(22) Filed: Dec. 29, 2000

(51) Int. Cl. G06F 15/16

(52) U.S. Cl. 709/231; 709/246

(57) ABSTRACT

Systems and methods are provided for dynamic distribution of audio signals at a site based on defined zones within the site. A plurality of addressable audio devices are coupled to a local network for the site which are configured to receive a designated digital audio stream over the local network and to output the received digital audio stream to audio equipment located at the site. A zone manager defines a plurality of zones for the site which may include a plurality of the addressable audio devices. The zone manager defines a relationship between a characteristic of the audio signal for a reference audio device and for the addressable audio devices in the zones. An audio interface receives digital audio streams and outputs the digital audio streams on the local network addressed to selected ones of the audio devices based on the defined zones, the defined relationship between a characteristic of the audio signal for a reference audio device and for the addressable audio devices and a control input associated with the characteristic. A user interface is provided which is configured to receive a user designation of the control input. Systems and methods for dynamic aggregation of audio equipment in zones are also provided.

### FIELD OF THE INVENTION

The present invention relates generally to audio signal communications, and more particularly to distribution of audio signals.

### BACKGROUND OF THE INVENTION

Increasingly, existing homes and homes under construction are being “networked” wherein communications cables (audio, video, data, and/or telecommunications cables) are being extended to many rooms and, in some cases, to multiple locations within each room. The benefits of “home networking” may include the ability to network multiple computers, printers and peripherals throughout a home and to access the Internet through a single high-speed connection; to listen to audio signals, such as music, from a selected signal source from any room in the house; to watch an internally modulated video signal such as a video cassette recorder (VCR), digital video disk (DVD), or satellite television receiver from any room in the home; to use a digital phone system, such as an ISDN line, throughout the home; to add security video cameras in the home and view them on any television; and to add future equipment that may allow a homeowner to use the same hand-held remote control in any room.

Home networking typically requires the use of a central distribution panel which serves as a gateway or interface to various communications services. Within these central distribution panels, cable distribution modules are typically utilized to receive a cable from a service provider or other signal source and distribute signals carried by the cables among various communications cables that are routed throughout the home. For example, a video cable distribution module may be configured to receive a cable television signal from a cable television service provider and distribute the signal to multiple cables routed within a home.

More particularly with reference to the home audio market, whole house audio currently may be provided broken into segments that can be described by the number of zones which are supported and the number and type of components in each whole house audio system. A whole house audio system generally includes a variety of audio components (such as amplifiers, tuners, CD players, etc.) and the speakers that deliver audio content to various rooms in a home. A zone in such systems is typically a single room, but may be more generally defined as a group of speakers that are driven by a single amplifier from a single source. A source can be an audio component such as a tuner, CD player, DVD player, VCR, or tape deck or it can be digital audio content from the Internet or digital music files, such as moving picture experts group (MPEG)-3 (MP3) format files.

The simplest and least expensive audio systems are typically comprised of a single zone, such as an entertainment room, with 2 or more speakers, an amplifier, and one or more audio sources. More complex systems may add multiple amplifiers to drive multiple zones and additional audio sources for independent zone audio sources. The most complex and expensive systems may provide multi-zone support using multi-channel (or architectural) amplifiers with up to 12 channels. Typically, a pair of channels is used to drive the left and right stereo channels for a pair of speakers, resulting in support for up to six zones with a 12 channel system. However, one or more of the channels can be used in mono mode to produce more than 6 total zones.

Architectural amplifiers can typically drive up to six or more zones and usually provide only volume control by zone. They do not generally directly support an equalization function on a per zone basis. Equalization typically involves controlling the amplification or volume of individual frequency ranges of an audio output. A typical equalizer allows the control of 10 or more frequency ranges, called bands, starting in the 40 Hertz (Hz) range and extending up to the 20,000 kHz range. An architectural amplifier can be coupled with external equalizer components to equalize individual zones.

Such audio zones are typically static. They are defined by the direct wiring, for example, of the six speaker out wire pairs from the architectural amplifier to the speakers in each room. Devices called speaker selectors are known which may allow the speaker outputs from any amplifier to be manually redirected to a single selectable zone.

It is known to that audio devices may be connected to a network. One particular type of audio device is an MP3 player. An MP3 player may be coupled to a network to receive a digital audio data stream and deliver audio speaker level output in stereo. Another type of network attached audio device from AVio Digital, Incorporated of San Carlos, Calif. is a multi-zoned network attached audio listening device based upon Avio's proprietary MediaWire™ technology. Such a device generally has the ability to dynamically configure and create active zones from devices connected to the network using the proprietary technology but is typically not compatible with non-proprietary network protocols such as the Internet protocols (IP). In effect, the devices are attached to a ‘party’ bus, in which they can be configured to listen to any of the “conversations” (audio streams) in progress.

Multi-channel audio mixers of up to 24 channels are also known for mixing audio signals. Some of these devices are now offered which could be connected using a Home Audio Video Interoperability (HAVi) connection and a personal computer (PC) based control mechanism. For example, a single studio PC could be configured to control many aspects of a multi-channel recording process.

Dolby Digital Laboratories, Inc. has introduced means for room equalization/audio processing. The Dolby design typically involves collecting parameterized information concerning a single room, performing some processing of an audio signal and outputting separate types of room sound effects, which may include “Church,” “Concert Hall,” and “Sports Arena.” This approach is based upon processing that is performed to achieve a given effect.

### SUMMARY OF THE INVENTION

Embodiments of the present invention provide systems and methods for dynamic distribution of audio signals at a site based on defined zones within the site. A plurality of addressable audio devices are coupled to a local network for the site which devices are configured to receive a designated digital audio stream over the local network and to output the received digital audio stream to audio equipment located at the site. A zone manager defines a plurality of zones for the site which may include a plurality of the addressable audio devices. The zone manager defines a relationship between a characteristic of the audio signal for a reference audio device and for the addressable audio devices in the zones. An audio interface receives digital audio streams and outputs the digital audio streams on the local network addressed to selected ones of the audio devices based on the defined zones, the defined relationship between a characteristic of the audio signal for a reference audio device and for the addressable audio devices and a control input associated with the characteristic. A user interface is provided which is configured to receive a user designation of the control input.

The characteristic may be a volume, a tone or a balance. The characteristic may also be an equalization specification and the audio devices may include an equalizer circuit. The audio interface and the zone manager in various embodiments are included in an Open Services Gateway initiative (OSGi) gateway configured to couple the local network to an external internet protocol network. The audio interface may also include a Real-time Transport Protocol (RTP) interface that outputs the digital audio streams using User Datagram Protocol (UDP).

In further embodiments of the present invention, the zone manager further includes a virtual effect circuit that generates a virtual effect defining a relationship between a characteristic of the audio signal for a reference audio device and for audio devices in a zone. The user interface may be configured to receive a designation of a desired virtual effect for a desired zone. The characteristic may be an equalization specification and the generated virtual effect may specify different equalizations to ones of the audio devices in the desired zone. In various embodiments, the desired virtual effect includes a plurality of different virtual effects, ones of which are applied to different ones of the audio devices in the desired zone.

In other embodiments of the present invention, the virtual effect circuit includes an audio mixer circuit that receives a plurality of designated digital audio streams and provides a mixed audio stream for output by the audio interface to at least one of the audio devices. The virtual effect may be a virtual reality effect and at least one designated digital audio stream may be associated with a reference position in the site. The audio mixer circuit may be configured to provide different mixed audio streams for at least two of the addressable audio devices wherein a characteristic of the at least one of the designated digital audio streams in the respective mixed audio streams is based on a relative position between associated audio equipment of the addressable audio devices and the reference position. The user interface may be configured to receive a user designation of a desired virtual reality effect as the control input. Furthermore, a plurality of designated digital audio streams may be associated with different reference positions in the site.

In further embodiments of the present invention, the relationship between a characteristic of the audio signal for a reference audio device and ones of the addressable audio devices is a relative relationship. The relative relationship between the reference audio device and ones of the addressable audio devices may be a proportional relationship and the relative relationship between the reference audio device and another of the addressable audio devices may be a static relationship. The digital audio streams may be MP3 streams.

In yet further embodiments of the present invention, a plurality of the addressable audio devices may be bundled on a shared substrate to provide a preamplifier. The preamplifier may have a single interface to the local network shared by the addressable audio devices on the preamplifier and a network switch circuit that routes digital audio streams to addressed ones of the addressable audio devices on the preamplifier.

In other embodiments of the present invention, site based dynamic distribution systems are provided for distributing an audio signal over a local network for the site. A network interface receives digital audio streams and outputs the digital audio streams on a local network for the site using an address based protocol. Ones of the digital audio streams have different associated identifiers. A plurality of network attached audio devices receives a selected digital audio stream over the local network for the site based on a designated one of the associated identifiers and outputs the received digital audio stream to audio equipment located at the site. Each of the respective network attached audio devices is associated with a group of audio equipment. A user interface receives a user designation of aggregations of the audio equipment located at the site. A controller coupled to the plurality of network attached audio devices designates the associated identifier to be received by respective ones of the plurality of network attached audio devices based on the user designation to provide dynamic zone aggregation of the audio equipment at the site.

In further embodiments of the present invention, the site is a residence and various of the groups of audio equipment are associated with respective rooms of the residence. The address based protocol may be a User Datagram Protocol (UDP) and may further be a Real-time Transport Protocol (RTP) and the network interface may be an RTP interface. The RTP interface may output the digital audio streams using time-stamped packets using UDP. The plurality of network attached audio devices may be configured to provide a salutation protocol to announce their presence to the controller over the local network. Furthermore, the controller may be configured to assign the associated address to be received by respective ones of the plurality of network attached audio devices to the network attached audio devices over the local network using the salutation protocol so as to group ones of the plurality of network attached audio devices.

In other embodiments of the present invention, methods are provided for dynamic distribution of an audio signal over a local network for a site. Digital audio streams are received at an interface to the local network. The digital audio streams are associated with identifiers and provided over the local network with the associated identifiers. A user designation of aggregations of groups of audio equipment at the site is received, each group of audio equipment being associated with an addressable audio device coupled to the local network. The identifiers associated with a digital audio stream to be received by the respective ones of the addressable audio devices in the aggregation of groups are dynamically designated to respective ones of the addressable audio devices in an aggregation of groups of audio equipment. A digital audio stream associated with the designated identifier is received at the respective ones of the addressable audio devices over the local network. The received digital audio stream is output to the groups of audio equipment associated with the respective ones of the addressable audio devices. The dynamic designations may be provided to the audio devices over the local network.

In further embodiments of the present invention, methods are provided for dynamic distribution of an audio signal in a zoned environment. A plurality of zones in the zoned environment are defined with at least one of the defined zones including at least two addressable audio devices. A relationship is defined between a characteristic of the audio signal for a reference audio device and for the selected addressable audio devices. The audio signal is distributed to the selected addressable audio devices based on the defined relationships and a control input associated with the characteristic. An update to the control input is received from a user and the audio signal is distributed to the selected addressable audio devices based on the defined relationships and the update to the control input. The audio signal may be received as a digital audio stream and may be distributed over a local network of the zoned environment.

While described above with reference to systems and methods, computer program products are also provided.

### BRIEF DESCRIPTION OF THE DRAWINGS

FIG. 1 is a block diagram of a site based dynamic distribution system according to embodiments of the present invention;

FIG. 2 is a block diagram of an addressable audio device suitable for use with embodiments of the present invention;

FIG. 3 is a block diagram of a site based dynamic distribution system circuit according to further embodiments of the present invention;

FIG. 4 is a block diagram of a site based dynamic distribution system circuit according to other embodiments of the present invention;

FIG. 5 is a flow chart illustrating operations for dynamic distribution of an audio signal over a local network for a site according to embodiments of the present invention;

FIG. 6 is a flow chart illustrating operations for dynamic distribution of an audio signal in a zoned environment according to embodiments of the present invention; and

FIG. 7 is a flow chart illustrating operations for control of audio signal settings on a source ID and user basis according to embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit.” Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®), Smalltalk or C++. However, the computer program code for carrying out operations of the present invention may also be written in conventional procedural programming languages, such as the “C” programming language or assembly language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

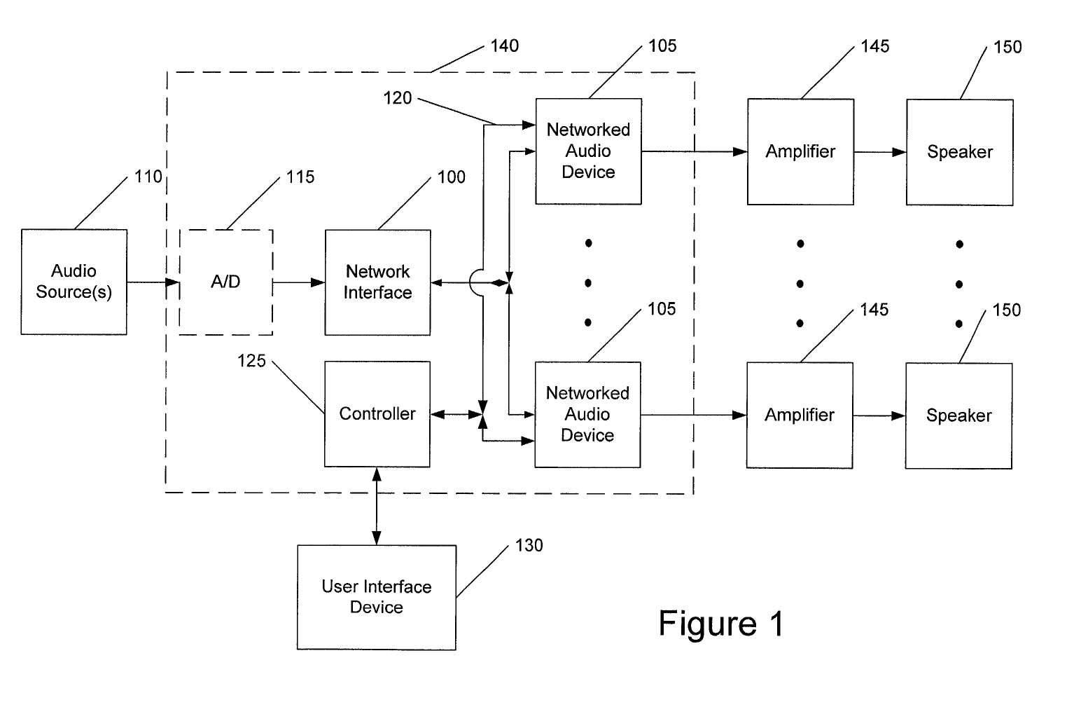

The present invention will now be described with reference to the embodiments illustrated in the figures. Referring first to FIG. 1, embodiments of site based dynamic distribution systems according to the present invention will be further described. As shown in FIG. 1, a site based dynamic distribution system for distributing an audio signal over a local network for the site includes a network interface 100 coupled to a plurality of network attached audio devices 105. An audio signal is received by the network interface 100 from an audio source 110. The audio source 110 may be a digital audio stream source such as, for example, a digital audio stream from the Internet or an outside device providing a digital audio stream in a format, for example, MP3. The audio source 110 may also be an analog audio source, in which case, an analog to digital converter 115 may convert a received analog signal to a digital audio stream and pass the digital audio stream to the network interface 100. A plurality of different types of audio sources 110 may be coupled by the network interface 100 to the local network 120 at the site.

The site may be a residence and the network 120 may be a home network. The home network may operate using a variety of protocols including, but not limited to, Ethernet. A controller 125 is provided which is coupled to the local network 120 and to a user device 130. Thus, the site based dynamic distribution system 140 receives audio signals from external audio sources 110 and control inputs from a user device(s) 130.

Each of the network attached audio devices 105 is associated with a group of audio equipment 145, 150. The respective groupings of audio equipment located at the site may, for example, each be associated with a different room in a residence. As shown in FIG. 1, a separate amplifier 145 and speaker(s) 150 are provided as audio equipment located at the site which equipment is responsive to a signal output from a particular network attached audio device 105. However, it is to be understood that the network attached audio devices 105 may include therein a pre-amplifier circuit and/or a pre-amplifier and amplifier circuits so that the speaker 150 may be driven directly by the audio devices 105 or driven though the amplifier 145 as illustrated in FIG. 1.

The network interface 100 receives digital audio streams and outputs the digital audio streams on the local network 120 using an address based protocol with each of the digital audio streams having a different associated identifier. The plurality of network attached audio devices 105 are configured to receive a selected one of the digital audio streams over the network 120 based on a designated one of the associated identifiers. The network attached audio devices 105 are further configured to output the received digital audio stream to the audio equipment 145, 150.

The user device 130, in combination with the controller 125, provides a user interface configured to receive a user designation of aggregations of the audio equipment 145, 150 located at the site so as to provide dynamic zone aggregation in various embodiments of the present invention. The controller 125 operates to designate the associated identifiers to be received by respective ones of the plurality of network attached audio devices 105. In other words, the controller 125 essentially tells the network audio devices 105 the “channel” to which they should tune. The controller 125 makes this designation based on the user designation from the user device 130 to provide dynamic zone aggregation. Thus, individual ones of the network attached audio devices may be grouped together and instructed to listen to the same channel to provide common audio signals to multiple rooms in a house while other groupings of the network attached audio devices 105 may be assigned a different channel to provide a different audio signal source in another set of rooms within the residence. Groups of the network attached audio devices 105 may be defined which provide a dynamically configurable virtual zone within the house for purposes of providing communication of audio signals over the local network 120.

One element of various embodiments of the present invention, as described above, is the ability to dynamically define aggregate zones. To accomplish this, the system provides the ability to add or remove audio device 105 to or from groups or virtual zones. Defining virtual zones involves assigning audio devices 105 to a particular network group. This will now be further described with reference to an example using the IP-based UDP protocol over an Ethernet network. However, the present invention is not limited to this protocol. For UDP over Ethernet, a UDP definition may specify the multicast group. The underlying transport for the digital audio streams should also be UDP. The audio source may thus deliver time-stamped packets to the proper multicast group. One such protocol, which defines delivery of audio content using UDP, is the Real-time Transport Protocol (RTP) as defined in request for comments (RFC) 1889.

When the audio devices 105 are powered they may use a salutation protocol (such as Universal Plug and Play (UPnP), Jini from Sun Microsystems or Salutation) to announce their presence on the network 120. The controller 125 with audio configuration capability collects a list of all the audio devices 105 and provides, in cooperation with the network interface 100, an interface for aggregating and segregating virtual zones and may use the same salutation protocol to distribute the interface. The audio devices 105 may then be remotely configured using the same salutation protocol to add them to network groups.

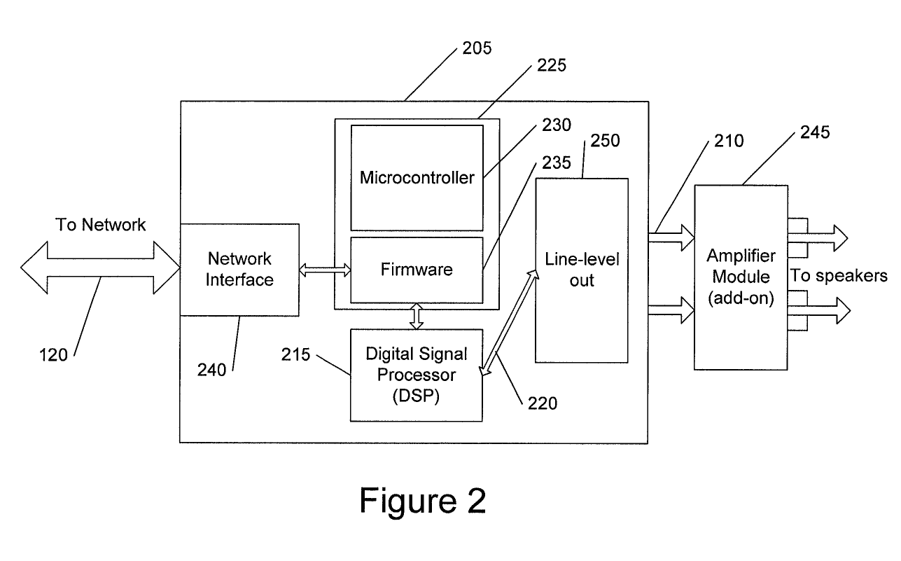

A network attached audio device 205 suitable for use with embodiments of the present invention will now be further described with reference to FIG. 2. As shown in FIG. 2, the network attached audio device 205 is configured to receive a digital audio stream from the network 120 and provide a speaker level output 210. The speaker level output 210 may be provided to an external amplifier 245 for delivery to speakers or the amplifier may be integrated into the network attached audio device 205.

As shown in the embodiments of FIG. 2, the audio device 205 includes a digital signal processor (DSP) 215 which converts the incoming digital audio stream to a line-level output 220. The DSP 215 may further include equalization functions and/or audio mixing function circuitry. The DSP 215 operates in cooperation with a control device 225 which includes a microcontroller 220 and firmware 235. The control device 225 provides protocol support for obtaining the digital audio stream from the local network 120 through a network interface 240 and providing the audio signal to the DSP 215 for further processing. The output signal from the DSP 215 is provided through the line-level output circuit 250 to the amplifier module 245.

The audio device 205 may, for example, receive an MP3 protocol stream as the input digital audio stream. An MP3 audio format may be beneficially utilized for applying equalization parameters to the audio stream in that the MP3 format generally breaks down the signal into a plurality of basic frequency ranges which may facilitate manipulation of the signal to provide an equalization function corresponding to that of a typical stereo equalizer component.

A plurality of these audio devices 105, 205, such as six or more, may be bundled in a single component, to provide a Network Architectural Preamplifier (NetPreAmp). The NetPreAmp may include a single network interface and a network switch which routes network traffic to the proper self-contained audio device. One or more network audio streams can be directed to one or more of the contained audio devices, providing the basic architectural amplifier structure.

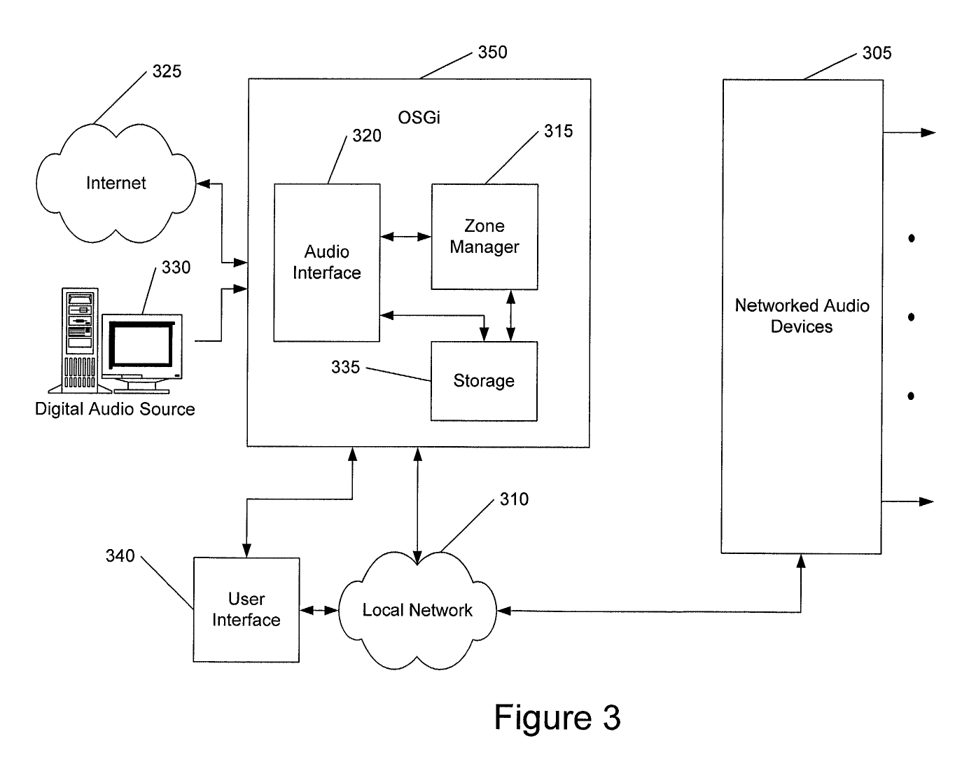

Referring now to the block diagram illustration of FIG. 3, a site based dynamic distribution system for distributing an audio signal over a local network for the site will now be further described. The system includes a plurality of addressable audio devices 305 coupled to a local network 310. The audio devices 305 output a received digital audio stream to audio equipment located at the site. Also shown are a zone manager 315, an audio interface 320 and a storage device 335 implemented as part of an Open Services Gateway interface (OSGi) 350. The OSGi interface is configured to couple the local network 310 to an external Internet protocol network(s) 325 and/or another digital audio source device(s) 330.

The zone manager 315 defines a plurality of zones for the site. The zones may include one or a plurality of the individual addressable audio devices included in the illustrated block of network audio devices 305. For ease of understanding in connection with the remainder of the description of FIG. 3, references to audio devices 305 refer to individual ones of the plurality of networked audio devices unless specified otherwise. The zone manager 315 defines a relationship between a characteristic of an audio signal being distributed for a reference audio device and for ones of the addressable audio devices 305 in respective zones. For example, the reference audio device may be an individual one of the provided addressable audio devices 305 associated with a specific room and a relationship may be provided between the characteristics for the audio signal in that room and other rooms included in a common zone with the base audio device room.

The characteristic may, for example, be any of a number of audio signal characteristics commonly associated with playing audio signals such as volume, tone, balance and spatialization. In various embodiments of the present invention, the characteristic is an equalization specification for the audio signal to be transmitted to the respective addressed audio devices 305. In such cases, the audio devices 305 further include an equalizer circuit configured to provide the desired equalization specification for delivery of the audio signal to their associated audio equipment.

The audio interface 320 receives the digital audio streams and outputs the digital audio streams on a local network 310 addressed (i.e., with an identifier of a particular audio stream which is detectable by the audio devices 305) to selected ones of the audio devices 305 based on the defined zones. The output is further based on the defined relationship between a characteristic of the audio signal for the reference audio device and for others of the audio devices in a zone. The output may also be provided based upon a control input associated with a characteristic, for example, a desired volume input for the kitchen may result in a different volume adjustment for other rooms grouped in a common zone with the kitchen. A user interface 340 is configured to receive a user designation of the control input.

The zone manager 315 may further include a virtual effect circuit that generates a virtual effect defining a relationship between a characteristic of the audio signal for a reference audio device and for ones of the audio devices in a specified one of the plurality of zones to which a virtual effect is to be applied. The user interface 340, in such embodiments, may be configured to receive a designation of a desired virtual effect for a desired one or more of the plurality of zones. For example, the characteristic may be an equalization specification and the generated virtual effect may specify different equalizations to individual ones of the audio devices 305 in a zone or zones for which the virtual effect is desired. Furthermore, the specified, desired virtual effect may itself be made up of a plurality of different virtual effects, different ones of which are applied to different ones of the audio devices 305.

As shown in the embodiment of FIG. 3, the plurality of network attached audio devices 305 are bundled on a shared substrate to provide a pre-amplifier. For example, the substrate may be a circuit card with an edge connector configured to be plugged into a bus interface for connection to the local network 310. The pre-amplifier in such embodiments may, thus, be provided a single interface to the local network 310 shared by each of the addressable audio devices 305 on the pre-amplifier. The pre-amplifier may further include a network switch circuit that routes digital audio streams to addressed ones of the addressable audio devices on the pre-amplifier. In addition, a plurality of such pre-amplifiers could be added to expand the number of supported channels.

The virtual zone aspects of the present invention will now be further described by way of example where each audio device is associated with a room in a residence. To create a Party virtual zone, a user might merge the living room, kitchen, deck, and main floor bathroom audio devices. By default, built-in virtual effects, like “Concert Hall” could be used with the Party virtual zone, which could cause all rooms to switch to their individual “Concert Hall” effects. The virtual effects could have different equalization and processing settings as characteristics of the audio signal for each room, but as a virtual effect, “Concert Hall” could be controlled as if it were a single effect. In addition, the user could define a virtual effect called “Party” which could be associated with the Party virtual zone. The Party virtual effect could in turn define a “Concert Hall” virtual effect for the living room, a “Low Key” virtual effect for the kitchen, a low-volume “Rock” virtual effect for the deck, and a “Muzak®” virtual effect for the bathroom.

The effect of volume or equalization changes to each audio device in a virtual zone could also be configured based on the type of room and the purpose of the audio content in each room. Because the main room is likely to be the living room, the living room audio device could be configured to “match” the equalization or volume changes to the reference zone of the virtual zone. For example, a 20 dB volume increase of the virtual zone would cause a 20 dB volume change in the living room (i.e., the living room would be the reference point). On the other hand, the bathroom audio may be intended as more of an ambient effect, and the user would probably not want a 20 dB volume increase in the bathroom. The bathroom audio device could, therefore, be configured to maintain a fixed or “static” volume level. The deck is another audio device “room” that may require a special relationship to the reference zone of the virtual zone. Even though the user is throwing a party, the user may not want to annoy neighbors, so the deck may be configured to maintain a “relative” relationship with the virtual zone. As an example of such a relative relationship, if the reference volume is increased 20 dB or 50%, the volume on the deck (which presumptively started out lower than the rest of the house) will increase by 50%, as well. Other relationships between individual rooms and the reference could also be used. For example, for every 5 dB increase in the reference, a room could increase 1 dB. Furthermore, a maximum decibel limit may be provided for a room or a virtual zone.

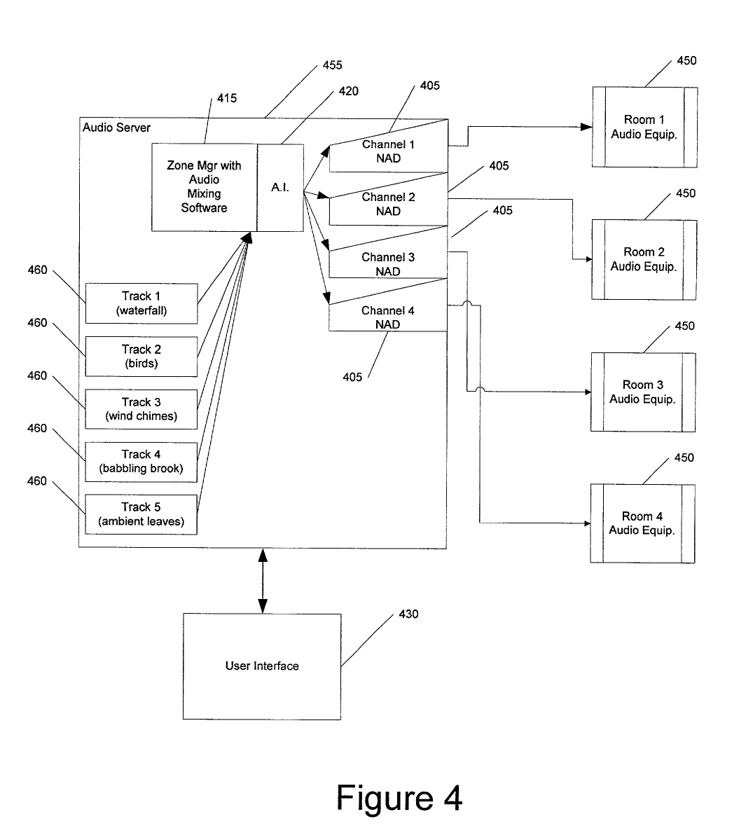

Referring now to FIG. 4, embodiments of a site based dynamic distribution system for distributing an audio signal over a local network for the site which embodiments include support for a virtual reality effect will be further described. As shown in FIG. 4, an audio server 455 includes a zone manager 415 and an audio interface 420 which couple a plurality of audio signal tracks 460 to a plurality of network addressable audio devices 405. The respective tracks 1-5 460 may, for example, be obtained from a storage device 335, from an Internet network 325, from another external digital audio source 330 or be provided by converting an analog signal source to digital.

Each of the network addressable audio devices 405 defines a channel which operates to drive associated audio equipment 450, such as speakers located in respective rooms of a residence. The network audio devices 405 may operate substantially as described previously for the audio devices 305. The zone manager 415 may operate in a manner similar to the zone manager 315 while further including an audio mixer circuit that receives a plurality of designated digital audio streams, such as the respective tracks 1-5 460 and provides a mixed audio stream for output by the audio interface 420 to the addressable audio devices 405.

To provide a virtual reality effect, one or more of the tracks 460 is associated with a reference position in the residence. For example, the waterfall of track 1 460 could be associated with a location serviced by the room 1 audio equipment 450 which is driven by the channel 1 audio device 405. The audio mixer circuit of the zone manager 415 is configured to provide different mixed audio streams for a plurality of the addressable audio devices 405 in which a characteristic of at least one of the plurality of designated digital audio streams included in the mixed audio stream is based on a relative position between the associated equipment receiving the mixed audio stream and the reference position. In other words, for example, the volume of the track 1 waterfall could be maintained at a loud level in its designated reference location at the room 1 audio equipment 450 with a proportionally reduced volume in each of the remaining rooms 2-4 based upon their distance within the residence from room 1. Other of the tracks 460 could be associated with different rooms. So, for example, a babbling brook (track 4) could be loud in room 3 and quieter in room 1, while the waterfall of track 1 would be louder in room 1 and quieter in room 3. Each output channel from the respective audio devices 405 may, thus, be a combination of one or more of the respective tracks 460 at different volumes to create the illusion of proximity to a respective sound source, thereby providing a virtual reality effect. Furthermore, some of the tracks included in the mix could be purely ambient tracks that provided no indication of proximity. The level of the respective tracks for each channel and which tracks to include in the mix for each channel may be pre-set by a manufacturer or configurable dynamic through a user interface 430.

The systems 140, 350, 305, 415 along with the user devices 130, 340, 430 provide an audio player as a device or interface, which control the configuration of an “audio network.” It can be provided as a true hardware device with knobs and flashing lights or as a software component that presents a user interface via a computer, either directly attached or remote via, for example, a network and HTML or some other markup language. The audio player may be visually configured to select a virtual zone or room/channel and a virtual effect can be associated with the selected channel(s). An audio signal source, such as a CD player, digital content from the Internet, or digital audio files on network storage, is also selected. The audio player then delivers the audio signal to the target virtual zone and/or channel using the proper network group and the proper encapsulation protocol. Channels can be added or removed from the virtual zone in some embodiments of the present invention by dynamically configuring additional audio devices to belong to the same network group.

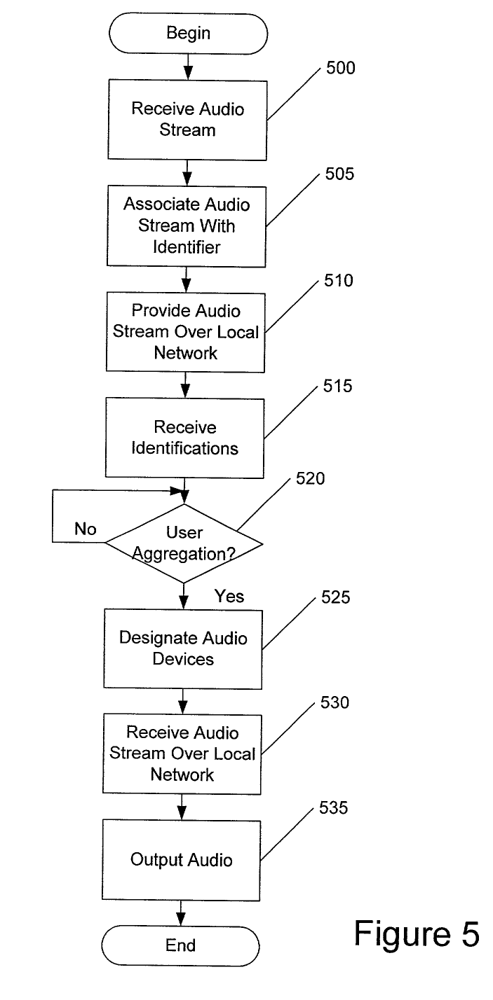

Operations for dynamic distribution of an audio signal over a local network for a site will now be further described with reference to the flowchart illustration of FIG. 5. More particularly, operations described with reference to FIG. 5 relate to dynamic aggregation of audio equipment groups into virtual zones. Operations begin at block 500 with receipt of a digital audio stream or streams at an interface to the local network. Received digital audio streams are associated with identifiers (block 505). The digital audio streams are provided over the local network with the associated identifiers (block 510).

In various embodiments of the present invention, the addressable audio devices further provide an announcement of their presence over the local area network, for example, utilizing a salutation protocol (block 515). The audio interface 320 and the zone manager 315 may, thus, be automatically notified of what audio devices 305 are available on the local network 310.

A user may, at various times, provide designations of ones of the groups of audio equipment at the site to be aggregated/segregated (block 520). Each group of audio equipment which is designated is associated with one of the addressable audio devices 305 so that, for example, an aggregation of groups of audio equipment may include groups of audio equipment in a plurality of different rooms with each group of audio equipment being associated with a room (or rooms) serviced by a particular addressable audio device 305 and a virtual zone across multiple rooms being provided by the aggregation of groups of audio equipment. The network interface 100 or audio interface 320 may, thus, dynamically designate respective ones of the addressable audio devices for inclusion in an aggregation of groups of audio equipment. (block 525). Furthermore, one of the identifiers associated with a digital audio stream to be received by the respective addressable audio devices in the group may be provided (block 525). The selection of a digital audio stream to which each audio device in a group will “tune” may be provided to the OSGi 350 as part of a received user designation at block 520. The digital audio stream associated with the designated identifier is then received at respective ones of the addressable audio devices over the local network (block 530). The received digital audio stream is then output to the groups of audio equipment associated with the addressable audio devices (block 535).

Dynamic designation may be provided to the audio devices over the local network. The digital audio streams may be provided over the local network based on UDP or based on Transport Control Protocol (TCP). Furthermore, RTP may be used to provide the digital audio streams using time-stamped packets over UDP. Furthermore, the designations provided at block 525 may be provided over the local network using the salutation protocol used by the respective audio devices to announce their presence at block 515.

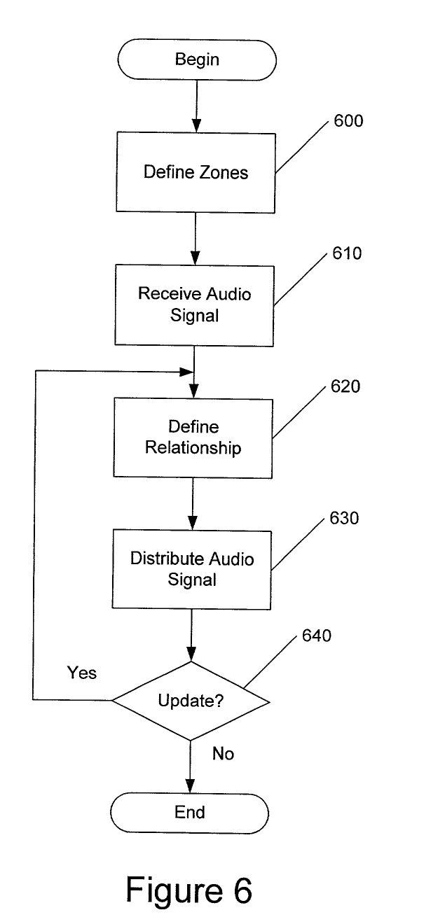

Referring now to the flowchart diagram of FIG. 6, operations for dynamic distribution of an audio signal in a zoned environment will now be further described for various embodiments of the present invention. More particularly, the description with reference to FIG. 6 will be directed to what may be referred to as the tone by zone or virtual effect aspects of the present invention. Operations in FIG. 6, begin at block 600 with defining a plurality of zones in the zoned environment. One or more of the defined zones may include a plurality of addressable audio devices 305, 405. An audio signal, such as a digital audio stream, is subsequently received (block 610). A relationship between a characteristic of the audio signal for a reference audio device and for a plurality of the addressable audio devices 305, 405 is defined (block 620). Such a relationship may be related to relative volume, equalization or other audio characteristics as described previously herein. Furthermore, such a relationship may be complex, proportional, or static as described previously herein.

The audio signal is distributed to a plurality of the audio devices 305, 405 based on the defined relationships and the control input associated with the characteristic(s) on which the defined relationship is based (block 630). An update to the control input specifying the characteristic(s) may be periodically received from a user (block 640). Where such an update is received (block 640), the relationship may be redefined if such a change is specified in the control input or may be simply applied to respective streams for different ones of the audio devices 305, 405 based on the existing relationships for distribution to the devices at block 630. Thus, the audio signal after receipt of a control input change is distributed to the plurality of audio devices 305, 405 based on the defined relationships and the update to the control input specifying the characteristic (block 630).

As described for various embodiments herein, the audio signal is preferably received as a digital audio stream which is distributed to the addressable audio devices 305, 405 over a local network 305 of the zoned environment. As noted, virtual effects may be provided according to the present invention when the virtual effect defines the relationship between the characteristic(s) of the audio signal for a reference audio device and for ones of the plurality of addressable audio devices 305, 405 in one or more of the specified zones. Furthermore, the received update or designation from the user at block 640 may include a designation of a desired virtual effect for a desired one or more of the plurality of designated zones.

More particularly, the characteristic may be an equalization specification in which case generating a virtual effect may comprise specifying different equalizations to respective ones of the audio devices 305, 405 grouped into a virtual zone for which the virtual effect is desired. Furthermore, as noted above, a desired virtual effect may include a plurality of different virtual effects, ones of which are applied to different ones of the audio devices in a designated zone. Furthermore, as describe primarily with reference to FIG. 4 above, it is to be understood that such operations may be provided in establishing virtual reality effects by providing mixing of multiple digital audio stream tracks where at least one of the tracks has an associated reference position within one of the rooms of a residence.

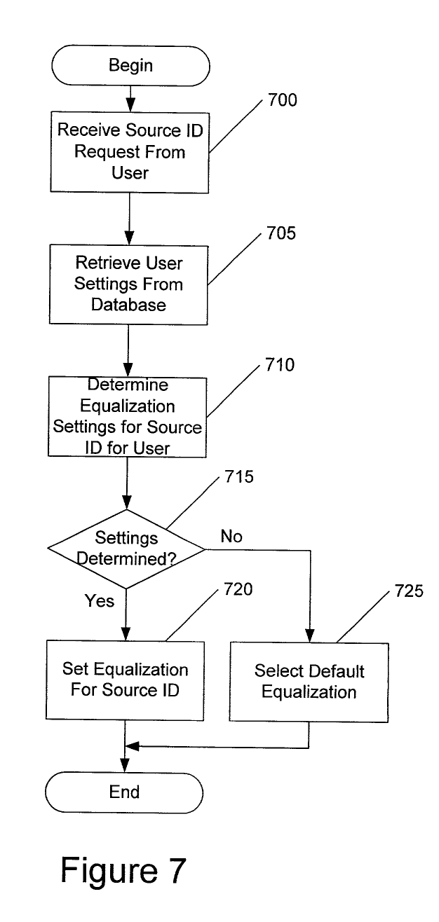

Referring now to the flowchart diagram of FIG. 7, operations for control of audio signal settings on a source ID and user basis according to embodiments of the present invention will now be further described. As discussed above a virtual effect may be created, such as “Concert Hall” by, for example, a suitable equalization setting. Furthermore, it is known in various music playing devices to control equalization based on a style (or genre) of music. However, such known approaches typically require a user to manually choose the equalization mode and, as a result, the equalization settings may not match the style/genre of a particular song. For example, a user must know that the user is listening to Rock music and choose the Rock equalization setting, this selection does not occur automatically. The user selection, in such known systems, may, for example, providing a scrolling list of optional settings for selection by a user. As will now be described with reference to FIG. 7, in accordance with embodiments of the present invention, a user may assign settings, such as equalization settings, to an audio source, such as songs or audio settings for video, on a source identification basis. For example, a particular song having an associated Source ID may be given a specific equalization setting for a particular user. In various embodiments, different settings may be provided for a song by different users. Similarly, different Source IDs may have a common equalization setting.

Operations begin in FIG. 7 with receipt of a request to play a particular Source ID audio source from an identified user (block 700). By way of example, User A may request playing of “Light Years” by Chick Corea. Audio settings (audio signal characteristics), such as equalization or spatialization for User A are retrieved from a settings database responsive to the received request (block 705). The retrieved database is searched for settings for the requested Source ID (block 710). The settings may provide for a single setting for the entire Source ID or provide a variable setting across the duration of play of the Source ID. For example, the cannons in the 1812 Overture could be provided an elevated volume based upon when in the play of the Source ID of the 1812 Overture the cannons took place.

If settings are found for the Source ID in the retrieved database (block 715), those settings are used to set, for example, the equalization for a player to play the Source ID for User A (block 720). If no settings are found for the Source ID in the retrieved database (block 715), then default settings are selected (block 725). For example, User A may request a new song for which User A has never designated a desired equalization. The default setting may be provided in a variety of manners. For example, a Source ID without a desired setting associated with User A may have a default setting specific to that Source ID. Different default settings may also be associated with each network addressable audio device 305, 405 or a plurality of such devices in a virtual zone.

While not illustrated in FIG. 7, User A may also be prompted at block 725 to select the default settings for the requested Source ID. In addition, User A may be prompted for an indication of whether the designated default setting should be added to the database for User A as a desired setting for the requested Source ID.

In particular embodiments, operations as illustrated in FIG. 7 may be implemented in extensible Markup Language (XML) and extensible Style Language (XSL) may be used to apply the equalization to the requested Source ID (referred to as “audiosource” in the code example below). As shown by the example code below, the “audiosource” may contain both a user ID and equalization ID that is used to do a lookup in an XSL database provided as the settings database discussed above. Those of skill in the art will understand that this example using XML/XSL is provided for purposes of illustration only and that other approaches may be used to implement this aspect of the present invention. The example XML/XSL code is as follows: XML:

XML:

<audiosource
name=“Light Years”
description=“Chick Corea”
genre=“Jazz”
type=“audio/mp3”
userid=“user1”
eqid=“AF78DE38”/>

XSL:

<user id=“user1”>

<eqsetting id=“AF78DE38”>

<band hzlower=“30”

hzupper=“120”
setting=“10”/>

<band hzlower=“120”

hzupper=“500”
setting=“−5”/>

<band hzlower=“500”

hzupper=“2000”
setting=“5”/>

<band hzlower=“2000”

hzupper=“16000”
setting=“5”/>

</eqsetting>

</user>

It will be understood that the block diagram and circuit diagram illustrations of FIGS. 1-7 and combinations of blocks in the block and circuit diagrams may be implemented using discrete and integrated electronic circuits. It will also be appreciated that blocks of the block diagram and circuit illustration of FIGS. 1-7 and combinations of blocks in the block and circuit diagrams may be implemented using components other than those illustrated in FIGS. 1-7, and that, in general, various blocks of the block and circuit diagrams and combinations of blocks in the block and circuit diagrams, may be implemented in special purpose hardware such as discrete analog and/or digital circuitry, combinations of integrated circuits or one or more application specific integrated circuits (ASICs).

Accordingly, blocks of the circuit and block diagrams of FIGS. 1-7 support electronic circuits and other means for performing the specified operations, as well as combinations of operations. It will be understood that the circuits and other means supported by each block and combinations of blocks can be implemented by special purpose hardware, software or firmware operating on special or general purpose data processors, or combinations thereof. It should also be noted that, in some alternative implementations, the operations noted in the blocks may occur out of the order noted in the figures. For example, two blocks shown in succession may, in fact, be executed substantially concurrently, or the blocks may sometimes be executed in the reverse order.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A site based dynamic distribution system for distributing an audio signal over a local network for the site, the system comprising:
a network interface that receives digital audio streams and outputs the digital audio streams on a local network for the site using an Internet protocol (IP) address based protocol and wherein ones of the digital audio streams have different associated identifiers;
a plurality of network attached audio devices configured to receive a selected digital audio stream over the local network for the site based on a designated one of the associated identifiers and to output the received digital audio stream to audio equipment located at the site, each of the respective network attached audio devices being associated with a different group of audio equipment;
a user interface configured to receive a user designation of aggregations of the audio equipment located at the site; and
a controller coupled to the plurality of network attached audio devices that designates the associated identifiers to be received by respective ones of the plurality of network attached audio devices based on the user designation to provide dynamic zone aggregation of the audio equipment at the site.

2. The system of claim 1 wherein the site is a residence and wherein ones of the groups of audio equipment are associated with respective rooms of the residence.

3. The system of claim 1 wherein the address based protocol comprises a User Datagram Protocol (UDP).

4. The system of claim 3 wherein the address based protocol further comprises a Real-time Transport Protocol (RTP) and the network interface comprises an RTP interface.

5. The system of claim 4 wherein the RTP interface outputs the digital audio streams using time-stamped packets using UDP.

6. The system of claim 1 wherein the plurality of network attached audio devices are configured to provide a salutation protocol to announce their presence to the controller over the local network.

7. The system of claim 6 wherein the controller is further configured to assign the associated identifier to be received by respective ones of the plurality of network attached audio devices to the network attached audio devices over the local network using the salutation protocol so as to group ones of the plurality of network attached audio devices.

8. A site based dynamic distribution system for distributing an audio signal over a local network for the site, the system comprising:
a plurality of addressable audio devices coupled to the local network and configured to receive a designated digital audio stream over the local network for the site and to output the received digital audio stream to audio equipment located at the site;
a zone manager that defines a plurality of zones for the site, at least one of the zones including at least two of the addressable audio devices and that defines a relationship between a characteristic of the audio signal for a reference audio device and for the at least two of the addressable audio devices in the at least one of the zones;
an audio interface that receives digital audio streams and outputs the digital audio streams on the local network addressed to selected ones of the audio devices based on the defined zones, the defined relationship between a characteristic of the audio signal for a reference audio device and for the at least two of the addressable audio devices and a control input associated with the characteristic; and
a user interface configured to receive a user designation of the control input.

9. The system of claim 8 wherein the characteristic is at least one of a volume, a tone and a balance.

10. The system of claim 8 wherein the characteristic is an equalization specification and wherein the audio devices further comprise an equalizer circuit.

11. The system of claim 8 wherein the audio interface and the zone manager are included in an Open Services Gateway initiative (OSGi) gateway configured to couple the local network to an external internet protocol network.

12. The system of claim 8 wherein the audio interface further comprises an RTP interface that outputs the digital audio streams using a UDP protocol.

13. The system of claim 8 wherein the zone manager further comprises a virtual effect circuit that generates a virtual effect defining a relationship between a characteristic of the audio signal for a reference audio device and for ones of the audio devices in a specified one of the plurality of zones and wherein the user interface is further configured to receive a designation of a desired virtual effect for a desired one of the plurality of zones.

14. The system of claim 13 wherein the characteristic is an equalization specification and wherein the generated virtual effect specifies different equalizations to ones of the audio devices in the desired one of the plurality of zones.

15. The system of claim 13 wherein the desired virtual effect comprises a plurality of different virtual effects, ones of which are applied to different ones of the audio devices in the desired one of the plurality of zones.

16. The system of claim 13 wherein the virtual effect circuit comprises an audio mixer circuit that receives a plurality of designated digital audio streams and provides a mixed audio stream for output by the audio interface to at least one of the audio devices.

17. The system of claim 16 wherein the virtual effect comprises a virtual reality effect and wherein at least one of the plurality of designated digital audio streams is associated with a reference position in the site and wherein the audio mixer circuit is configured to provide different mixed audio streams for at least two of the addressable audio devices wherein a characteristic of the at least one of the plurality of designated digital audio streams in the respective mixed audio streams is based on a relative position between associated audio equipment of the at least two of the addressable audio devices and the reference position.

18. The system of claim 17 wherein the user interface is configured to receive a user designation of a desired virtual reality effect as the control input.

19. The system of claim 17 wherein a plurality of designated digital audio streams are associated with different reference positions in the site.

20. The system of claim 8 wherein the relationship between a characteristic of the audio signal for a reference audio device and the at least two of the addressable audio devices comprises a relative relationship.

21. The system of claim 20 wherein the relative relationship between the reference audio device and one of the at least two of the addressable audio devices is a proportional relationship and wherein the relative relationship between the reference audio device and another of the at least two of the addressable audio devices is a static relationship.

22. The system of claim 8 wherein the digital audio streams are MP3 streams.

23. The system of claim 20 wherein the relative relationship between the reference audio device and one of the at least two of the addressable audio devices comprises a maximum level.

24. The system of claim 8 wherein a plurality of the addressable audio devices are bundled on a shared substrate to provide a preamplifier, the preamplifier having a single interface to the local network shared by the addressable audio devices on the preamplifier and a network switch circuit that routes digital audio streams to addressed ones of the addressable audio devices on the preamplifier.

25. A method for dynamic distribution of an audio signal over a local network for a site, the method comprising:
receiving digital audio streams at an interface to the local network;
associating the digital audio streams with identifiers;
providing the digital audio streams over the local network with the associated identifiers using an Internet protocol (IP) address based protocol;
receiving a user designation of aggregations of groups of audio equipment at the site, each group of audio equipment being associated with an addressable audio device coupled to the local network;
dynamically designating to respective ones of the addressable audio devices in an aggregation of groups of audio equipment one of the identifiers associated with a digital audio stream to be received by the respective ones of the addressable audio devices in the aggregation of groups and output to their associated group of audio equipment responsive to the received user designation;
receiving the digital audio stream associated with the designated identifier at the respective ones of the addressable audio devices over the local network; and
outputting the received digital audio stream to the groups of audio equipment associated with the respective ones of the addressable audio devices.

26. The method of claim 25 wherein the dynamic designations are provided to the audio devices over the local network.

27. The method of claim 26 wherein providing the digital audio streams over the local network further comprises providing the digital audio streams over the local network based on a User Datagram Protocol (UDP).

28. The method of claim 27 wherein providing the digital audio streams over the local network further comprises providing the digital audio streams over the local network based on a Real-time Transport Protocol (RTP).

29. The method of claim 28 wherein RTP provides the digital audio streams using time-stamped packets using UDP.

30. The method of claim 25 further comprising the step performed by the addressable audio devices of providing a salutation protocol to announce their presence over the local network.

31. The method of claim 30 wherein the dynamic designations are provided to the addressable audio devices over the local network using the salutation protocol so as to group ones of the plurality of network attached audio devices.

32. A method for dynamic distribution of an audio signal in a zoned environment, the method comprising:
defining a plurality of zones in the zoned environment, at least one of the defined zones including at least two addressable audio devices;
defining a relationship between a characteristic of the audio signal for a reference audio device and for the at least two of the addressable audio devices;
distributing the audio signal to the at least two of the addressable audio devices based on the defined relationships and a control input associated with the characteristic;
receiving an update to the control input from a user; and
distributing the audio signal to the at least two of the addressable audio devices based on the defined relationships and the update to the control input.

33. The method of claim 32 further comprising receiving the audio signal as a digital audio stream and wherein the steps of distributing the audio signal to the at least two of the addressable audio devices comprise distributing the digital audio stream over a local network of the zoned environment.

34. The method of claim 33 wherein the step of defining a relationship further comprises generating a virtual effect that defines a relationship between a characteristic of the audio signal for a reference audio device and for ones of the audio devices in a specified one of the plurality of zones and wherein the method further comprises receiving a designation of a desired virtual effect for a desired one of the plurality of zones.

35. The method of claim 34 wherein the characteristic is an equalization specification and wherein the step of generating a virtual effect further comprises specifying different equalizations to ones of the audio devices in the desired one of the plurality of zones.

36. The method of claim 34 wherein the desired virtual effect comprises a plurality of different virtual effects, ones of which are applied to different ones of the audio devices in the desired one of the plurality of zones.

37. The method of claim 34 wherein the step of receiving the audio signal as a digital audio stream further comprises the step of receiving a plurality of digital audio streams and wherein generating a virtual effect further comprises generating a mixed audio stream from ones of the received plurality of digital audio streams for distribution to at least one of the addressable audio devices over the local network.

38. The method of claim 37 wherein the virtual effect comprises a virtual reality effect and wherein at least one of the plurality of designated digital audio streams is associated with a reference position in the zoned environment and wherein the step of generating a mixed audio stream further comprises the step of generating different mixed audio streams for at least two of the addressable audio devices wherein a characteristic of the at least one of the plurality of designated digital audio streams in the respective mixed audio streams is based on a relative position between associated audio equipment of the at least two of the addressable audio devices and the reference position.

39. The method of claim 38 further comprising receiving a user designation of a desired virtual reality effect as the control input.

40. The method of claim 38 wherein a plurality of designated digital audio streams are associated with different reference positions in the zoned environment.

41. A computer program product for dynamic distribution of an audio signal over a local network for a site, the computer program product comprising:
a computer-readable storage medium having computer-readable program code embodied in said medium, said computer-readable program code comprising:
computer-readable program code which receives digital audio streams at an interface to the local network;
computer-readable program code which associates the digital audio streams with identifiers;
computer-readable program code which provides the digital audio streams over the local network with the associated identifiers;
computer-readable program code which receives a user designation of aggregations of groups of audio equipment at the site, each group of audio equipment being associated with an addressable audio device coupled to the local network;
computer-readable program code which dynamically designates to respective ones of the addressable audio devices in an aggregation of groups of audio equipment one of the identifiers associated with a digital audio stream to be received by the respective ones of the addressable audio devices in the aggregation of groups and output to their associated group of audio equipment responsive to the received user designation;
computer-readable program code which receives the digital audio stream associated with the designated identifier at the respective ones of the addressable audio devices over the local network; and
computer-readable program code which outputs the received digital audio stream to the groups of audio equipment associated with the respective ones of the addressable audio devices.

42. A computer program product for dynamic distribution of an audio signal in a zoned environment, the computer program product comprising:
a computer-readable storage medium having computer-readable program code embodied in said medium, said computer-readable program code comprising:
computer-readable program code which defines a plurality of zones in the zoned environment, at least one of the defined zones including at least two addressable audio devices;
computer-readable program code which defines a relationship between a characteristic of the audio signal for a reference audio device and for the at least two of the addressable audio devices;
computer-readable program code which distributes the audio signal to the at least two of the addressable audio devices based on the defined relationships and a control input associated with the characteristic;
computer-readable program code which receives an update to the control input from a user; and
computer-readable program code which distributes the audio signal to the at least two of the addressable audio devices based on the defined relationships and the update to the control input.
